(19) United States
(12) Patent Application Publication
(10) Pub. No.: US 2026/0171026 A1
(43) Pub. Date: Jun. 18, 2026

(54) DISPLAY DEVICE INCLUDING DRIVING TRANSISTOR

(71) Applicant: LG Display Co., Ltd., Seoul (KR)

(72) Inventor: Tae-Keun LEE, Paju-si (KR)

(21) Appl. No.: 19/334,622

(22) Filed: Sep. 19, 2025

(30) Foreign Application Priority Data
Dec. 17, 2024 (KR) 10-2024-0188625

(51) Int. Cl. G09G 3/3258; G09G 3/32

(52) U.S. Cl. CPC G09G 3/3258; G09G 3/32; G09G 2300/043; G09G 2300/0819; G09G 2310/08; G09G 2320/0233

(57) ABSTRACT

A display device includes: a display panel; a first transistor switched according to a voltage of a second node and connected to first and third nodes; a second transistor switched according to a scan1 signal and connected to the second and third nodes; a third transistor switched according to a scan2 signal and connected to the first node; a fourth transistor switched according to an emission signal and connected to the first node; a fifth transistor switched according to the emission signal and connected to the third and fourth nodes; a sixth transistor switched according to a scan4 signal and connected to the second node; a seventh transistor switched according to a scan3 signal and connected to the fourth node; an eighth transistor switched according to the scan3 signal and connected to the first node; and a light emitting diode connected to the fourth node.

### CROSS-REFERENCE TO RELATED APPLICATION

Pursuant to 35 U.S.C. § 119(a), this application claims the benefit of an earlier filing date and right of priority to Korean Patent Application No. 10-2024-0188625, filed on December 17, 2024, the contents of which are hereby incorporated by reference in their entirety.

### TECHNICAL FIELD

The present disclosure relates generally to a display device.

### BACKGROUND

Recently, various flat panel display devices such as a liquid crystal display device (LCD), an organic light emitting diode (OLED) display device and a field emission display (FED) device having excellent properties of a thin profile, a light weight and a low power consumption have been developed and applied to various fields.

### SUMMARY

In an aspect of the present disclosure, a display device includes: a display panel including a display area having a plurality of subpixels and a non-display area at a periphery of the display area; a first transistor in each of the plurality of subpixels, the first transistor switched according to a voltage of a second node and connected to a first node and a third node; a second transistor in each of the plurality of subpixels, the second transistor switched according to a scan1 signal and connected to the second node and the third node, and the second transistor having a double gate type; a third transistor in each of the plurality of subpixels, the third transistor switched according to one of an odd scan2 signal and an even scan2 signal and connected to a data signal and the first node; a fourth transistor in each of the plurality of subpixels, the fourth transistor switched according to an emission signal and connected to a high level signal and the first node; a fifth transistor in each of the plurality of subpixels, the fifth transistor switched according to the emission signal and connected to the third node and a fourth node; a sixth transistor in each of the plurality of subpixels, the sixth transistor switched according to a scan4 signal and connected to an initial signal and the second node; a seventh transistor in each of the plurality of subpixels, the seventh transistor switched according to a scan3 signal and connected to an anode reset signal and the fourth node; an eighth transistor in each of the plurality of subpixels, the eighth transistor switched according to the scan3 signal and connected to a stress signal and the first node; and a light emitting diode in each of the plurality of subpixels, the light emitting diode connected to a low level signal and the fourth node.

It is to be understood that both the foregoing general description and the following detailed description are explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this specification, illustrate implementations of the disclosure and together with the description serve to explain the principles of the disclosure.

In the drawings:

FIG. 1 is a view showing a display device according to a first implementation of the present disclosure.

FIG. 2 is a block diagram showing first and second gate driving units and a display panel of a display device according to a first implementation of the present disclosure.

FIG. 3 is a circuit diagram showing a subpixel of a display device according to a first implementation of the present disclosure.

FIG. 4 is a cross-sectional view showing a subpixel of a display panel of a display device according to a first implementation of the present disclosure.

FIG. 5 is a plan view showing first, second and sixth transistors of a display device according to a first implementation of the present disclosure.

FIG. 6 is a cross-sectional view taken along a line VI-VI of FIG. 5.

FIG. 7 is a view showing a plurality of signals of one frame of a display device according to a first implementation of the present disclosure.

FIG. 8A is a view showing a second node voltage of a display device according to a comparison example.

FIG. 8B is a view showing a second node voltage of a display device according to a first implementation of the present disclosure.

FIG. 9 is a circuit diagram showing a subpixel of a display device according to a second implementation of the present disclosure.

FIG. 10 is a view showing a first gate driving unit and a display panel of a display device according to a second implementation of the present disclosure.

FIG. 11 is a cross-sectional view showing an output line and a carry line of a first gate driving unit of a display device according to a second implementation of the present disclosure.

FIG. 12 is a view showing a scan1 signal and a scan2 signal of a display device according to a second implementation of the present disclosure.

FIG. 13 is a view showing a subpixel of a display device according to a third implementation of the present disclosure.

FIG. 14 is a plan view showing first, second and sixth transistors of a display device according to a third implementation of the present disclosure.

FIG. 15 is a cross-sectional view taken along a line XV-XV of FIG. 14.

FIG. 16 is a cross-sectional view taken along a line XVI-XVI of FIG. 14.

### DETAILED DESCRIPTION

A display device generally includes a display panel displaying an image and a driving unit supplying a signal and a power to the display panel. The driving unit includes a gate driving unit and a data driving unit supplying a gate voltage and a data voltage, respectively, to each pixel of the display panel.

The display device can display an image by compensating a threshold voltage of a driving transistor of each subpixel. However, problems can occur because the measured threshold voltage can vary across the display device due to a mobility difference between a transistor for detecting the threshold voltage and the driving transistor. As such, deterioration such as a local luminance deviation may occur.

Implementations of the present disclosure can provide a display device wherein a gate electrode of a driving transistor is charged to the same voltage regardless of a mobility deviation of a sampling transistor.

In some implementations, a display device is provided where deterioration such as a local luminance deviation can be mitigated, and a display quality can be improved. The improvements can be achieved by reduction of a difference of a measured threshold voltage by reducing a width of an initialization period and charging up a gate electrode of a driving transistor with the same voltage regardless of a mobility deviation of a sampling transistor.

Further, implementations of the present disclosure can provide a display device where deterioration such as a local luminance deviation can be mitigated, and a low power driving can be obtained due to reduction of a difference of a measured threshold voltage by forming a coupling capacitor between a scan1 signal and a scan2 signal and increasing an on-current of a sampling transistor.

Additional features and advantages of the disclosure will be set forth in the description which follows, and in part will be apparent from the description, or may be learned by practice of the disclosure. These and other advantages of the disclosure will be realized and attained by the structure particularly pointed out in the written description and claims hereof as well as the appended drawings.

Advantages and features of the present disclosure, and implementation methods thereof will be clarified through following example aspects described with reference to the accompanying drawings. The present disclosure may, however, be embodied in different forms and should not be construed as limited to the example aspects set forth herein. Rather, these example aspects are provided so that this disclosure may be sufficiently thorough and complete to assist those skilled in the art to fully understand the scope of the present disclosure. Further, the present disclosure is only defined by scopes of claims.

The shapes, sizes, ratios, angles, numbers, and the like, which are illustrated in the drawings to describe various example aspects of the present disclosure, are merely given by way of example. Therefore, the present disclosure is not limited to the illustrations in the drawings. Like reference numerals refer to like elements throughout the specification, unless otherwise specified.

In the following description, where the detailed description of the relevant known function or configuration may unnecessarily obscure a feature or aspect of the present disclosure, a detailed description of such known function or configuration may be omitted or a brief description may be provided.

Where the terms "comprise," "have," "include," and the like are used, one or more other elements may be added unless the term, such as "only," is used. An element described in the singular form is intended to include a plurality of elements, and vice versa, unless the context clearly indicates otherwise.

In construing an element, the element is to be construed as including an error or a tolerance range even where no explicit description of such an error or tolerance range is provided.

Where positional relationships are described, for example, where the positional relationship between two parts is described using "on," "over," "under," "above," "below," "beside," "next," or the like, one or more other parts may be located between the two parts unless a more limiting term, such as "immediate(ly)," "direct(ly)," or "close(ly)" is used. For example, where an element or layer is disposed "on" another element or layer, a third layer or element may be interposed therebetween.

Although the terms "first," "second," A, B, (a), (b), and the like may be used herein to refer to various elements, these elements should not be interpreted to be limited by these terms as they are not used to define a particular order or precedence. These terms are only used to distinguish one element from another. For example, a first element could be termed a second element, and, similarly, a second element could be termed a first element, without departing from the scope of the present disclosure.

The term "at least one" should be understood to include all combinations of one or more of related elements. For example, the term of "at least one of first, second and third elements" may include all combinations of two or more of the first, second and third elements as well as the first, second or third element.

The term "display device" may include a display device in a narrow sense such as liquid crystal module (LCM), an organic light emitting diode (OLED) module and a quantum dot (QD) module including a display panel and a driving unit for driving the display panel. In addition, the term "display device" may include a complete product (or a final product) including the LCM, the OLED module and the QD module such as a notebook computer, a television, a computer monitor, an equipment display device including an automotive display apparatus or other industrial or consumer equipment displays, and a set electronic apparatus or a set device (or a set apparatus) such as a mobile electronic apparatus of a smart phone or an electronic pad.

Accordingly, a display device of the present disclosure may include an applied product or a set device of a final user's device including the LCM, the OLED module and the QD module as well as a display device in a narrow sense such as the LCM, the OLED module and the QD module.

According to circumstances, the LCM, the OLED module and the QD module having a display panel and a driving unit may be expressed as "a display device", and an electronic apparatus of a complete product including the LCM, the OLED module and the QD module may be expressed as "a set device." For example, a display device in a narrow sense may include a display panel of a liquid crystal, an organic light emitting diode and a quantum dot and a source printed circuit board (PCB) of a control unit for driving the display panel, and a set device may further include a set PCB of a set control unit electrically connected to the source PCB for controlling the entire set device.

The display panel of the present disclosure may include all kinds of display panels such as a liquid crystal display panel, an organic light emitting diode display panel, a quantum dot display panel and an electroluminescent display panel. The display panel of the present disclosure is not limited to a specific display panel of a bezel bending having a flexible substrate for an organic light emitting diode display panel and a lower back plate supporter. A shape or a size of the display panel for the display device of the present disclosure is not limited thereto.

For example, when the display panel is an organic light emitting diode display panel, the display panel may include a plurality of gate lines, a plurality of data lines and a subpixel in a crossing region of the plurality of gate lines and the plurality of data lines. The display panel may include an array having a thin film transistor of an element for selectively applying a voltage to each subpixel, an emitting element layer on the array and an encapsulating substrate or an encapsulation part covering the emitting element layer. The encapsulation part may protect the thin film transistor and the emitting element layer from an external impact and may prevent or at least reduce penetration of a moisture or oxygen into the emitting element layer. In addition, the emitting element layer on the array may include an inorganic light emitting layer, for example, a nano-sized material layer or a quantum dot.

The thin film transistor of the present disclosure may include one of an oxide thin film transistor, an amorphous silicon thin film transistor, and a low temperature polycrystalline silicon thin film transistor.

Features of various implementations of the present disclosure may be partially or entirely coupled to or combined with each other. They may be linked and operated technically in various ways as those skilled in the art may sufficiently understand. The aspects may be carried out independently of or in association with each other in various combinations.

Hereinafter, a display device according to various example implementations of the present disclosure where an influence on an oxide semiconductor layer of a thin film transistor of a driving element is reduced by shielding a light emitted and transmitted from a subpixel and/or a light inputted from an exterior will be described in detail with reference to the accompanying drawings.

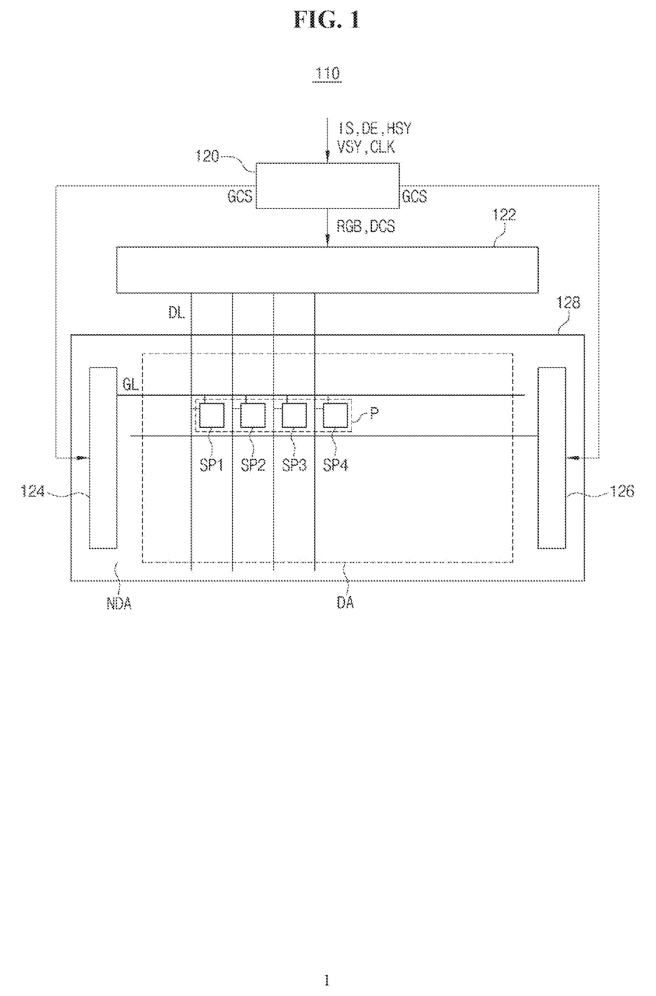

FIG. 1 is a view showing a display device according to a first implementation of the present disclosure. Although the display device may be an organic light emitting diode (OLED) display device, it is not limited thereto. For example, the display device may be a quantum dot display device, a micro light emitting diode (LED) display device or a mini light emitting diode (LED) display device.

In FIG. 1, a display device 110 according to a first implementation of the present disclosure includes a timing controlling unit 120 (e.g., a circuit), a data driving unit 122 (e.g., a circuit), first and second gate driving units 124 and 126 (e.g., circuits) and a display panel 128.

The timing controlling unit 120 generates an image data RGB, a data control signal DCS and a gate control signal GCS using an image signal IS and a plurality of timing signals including a data enable signal DE, a horizontal synchronization signal HSY, a vertical synchronization signal VSY and a clock signal CLK transmitted from an external system such as a graphic card or a television system.

The timing controlling unit 120 transmits the image data RGB and the data control signal DCS to the data driving unit 122 and transmits the gate control signal GCS to the first and second gate driving units 124 and 126.

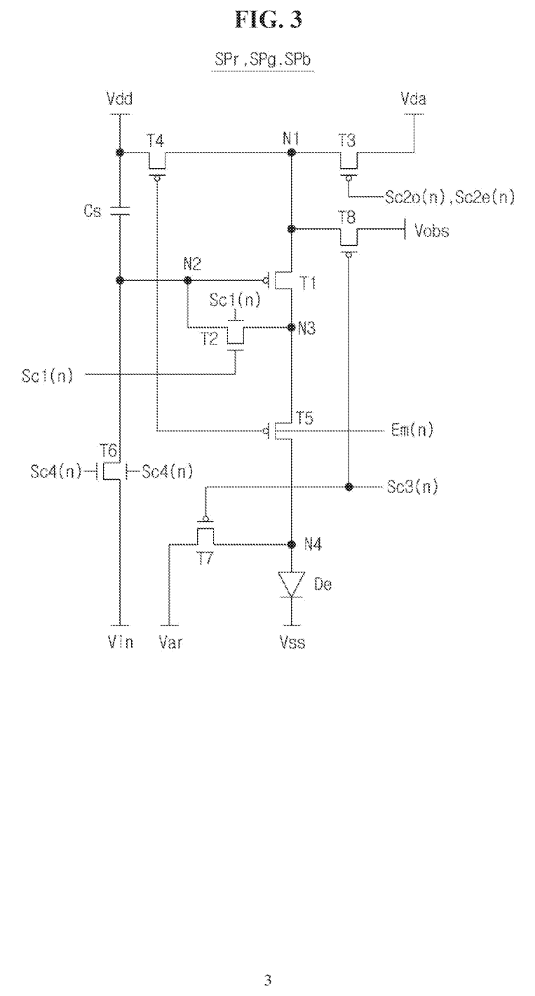

The data driving unit 122 generates a data signal (data voltage) Vda (of FIG. 3) using the image data RGB and the data control signal DCS transmitted from the timing controlling unit 120 and applies the data signal Vda to a data line DL of the display panel 128.

The first and second gate driving units 124 and 126 generate gate signals (gate voltages) Sc1(n), Sc2o(n), Sc2e(n), Sc3(n), Sc4(n) and Em(n) (of FIG. 3) using the gate control signal GCS transmitted from the timing controlling unit 120 and apply the gate signals Sc1(n), Sc2o(n), Sc2e(n), Sc3(n), Sc4(n) and Em(n) to a gate line GL of the display panel 128.

The first and second gate driving units 124 and 126 may have a gate in panel (GIP) type to be formed in a non-display area NDA of a substrate of the display panel 128 having the gate line GL, the data line DL and a pixel P.

Although the first and second gate driving units 124 and 126 are disposed in both side portions of the display panel 128 in a first implementation of FIG. 1, one gate driving unit may be disposed in one side portion of the display panel 128 in another implementation.

The display panel 128 includes a display area DA at a central portion thereof and a non-display area NDA surrounding the display area DA. The display panel 128 displays an image using the gate signals Sc1(n), Sc2o(n), Sc2e(n), Sc3(n), Sc4(n) and Em(n) and the data signal Vda. For displaying an image, the display panel 128 includes a plurality of pixels P, a plurality of gate lines GL and a plurality of data lines DL in the display area DA.

Each of the plurality of pixels P includes first, second, third and fourth subpixels SP1, SP2, SP3 and SP4. The gate line GL and the data line DL cross each other to define the first, second, third and fourth subpixels SP1, SP2, SP3 and SP4, and each of the first, second, third and fourth subpixels SP1, SP2, SP3 and SP4 is connected to the gate line GL and the data line DL.

For example, the first, second, third and fourth subpixels SP1, SP2, SP3 and SP4 may correspond to red, green, blue and white colors, respectively.

Although one pixel P exemplarily includes the first, second, third and fourth subpixels SP1, SP2, SP3 and SP4 in a first implementation of FIG. 1, one pixel P may include first, second and third subpixels SP1, SP2 and SP3 corresponding to red, green and blue colors, respectively, in another implementation.

When the display device 110 is an organic light emitting diode (OLED) display device, each of the first, second, third and fourth subpixels SP1, SP2, SP3 and SP4 may include a plurality of transistors such as a switching transistor, a driving transistor and a sampling transistor, a storage capacitor and a light emitting diode.

A structure of the display panel 128 and the subpixels SP1 to SP4 of the display device 110 will be illustrated with reference to drawings.

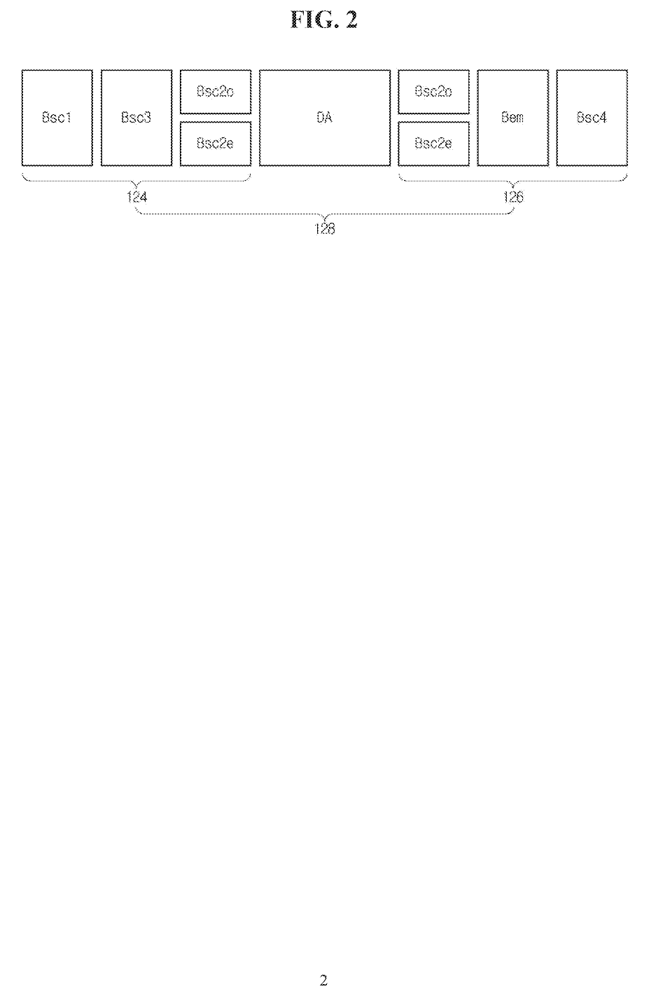

FIG. 2 is a block diagram showing first and second gate driving units and a display panel of a display device according to a first implementation of the present disclosure, and FIG. 3 is a circuit diagram showing a subpixel of a display device according to a first implementation of the present disclosure.

In FIG. 2, the first gate driving unit 124 of the display device 110 according to a first implementation of the present disclosure includes a scan1 block Bsc1, an odd scan2 block Bsc2o, an even scan2 block Bsc2e and a scan3 block Bsc3, and the second gate driving unit 126 of the display device 110 according to a first implementation of the present disclosure includes an odd scan2 block Bsc2o, an even scan2 block Bsc2e, a scan4 block Bsc4 and an emission block Bem. The display area DA of the display panel 128 is disposed between the first and second gate driving units 124 and 126.

In another implementation, the disposition structure of the scan1 block Bsc1, the odd scan2 block Bsc2o, the even scan2 block Bsc2e, the scan3 block Bsc3, the scan4 block Bsc4 and the emission block Bem in the first and second gate driving units 124 and 126 may be variously changed.

For example, the scan1 block Bsc1 may be disposed farther from the display panel 128 than the scan3 block Bsc3 and the scan4 block Bsc4 may be disposed farther from the display panel 128 than the emission block Bem in a first implementation of FIG. 2. In another implementation, the scan3 block Bsc3 may be disposed farther from the display panel 128 than the scan1 block Bsc1 and the emission block Bem may be disposed farther from the display panel 128 than the scan4 block Bsc4.

Each of the scan1 block Bsc1, the odd scan2 block Bsc2o, the even scan2 block Bsc2e and the scan3 block Bsc3 of the first gate driving unit 124 and the odd scan2 block Bsc2o, the even scan2 block Bsc2e, the scan4 block Bsc4 and the emission block Bem of the second gate driving unit 126 may be one stage of a shift register, and the shift register may include a plurality of stages connected to each other in a cascade type.

In the first gate driving unit 124, the scan1 block Bsc1, the odd scan2 block Bsc2o, the even scan2 block Bsc2e and the scan3 block Bsc3 generate a scan1 signal Sc1(n) (of FIG. 3), an odd scan2 signal Sc2o(n) (of FIG. 3), an even scan2 signal Sc2e(n) (of FIG. 3) and a scan3 signal Sc3(n) (of FIG. 3), respectively.

In the second gate driving unit 126, the odd scan2 block Bsc2o, the even scan2 block Bsc2e, the scan4 block Bsc4 and the emission block Bem generate the odd scan2 signal Sc2o(n), the even scan2 signal Sc2e(n), a scan4 signal Sc4(n) (of FIG. 3) and an emission signal Em(n) (of FIG. 3), respectively.

The scan1 signal Sc1(n) of the scan1 block Bsc1 is supplied to a second transistor T2 (of FIG. 3) in each subpixel SP1 to SP4 of odd and even horizontal pixel lines of the display area DA through the gate line GL. The odd scan2 signal Sc2o(n) of the odd scan2 block Bsc2o is supplied to a third transistor T3 (of FIG. 3) in each subpixel SP1 to SP4 of the odd horizontal pixel line of the display area DA through the gate line GL, and the even scan2 signal Sc2e(n) of the even scan2 block Bsc2e is supplied to the third transistor T3 in each subpixel SP1 to SP4 of the even horizontal pixel line of the display area DA through the gate line GL.

The scan3 signal Sc3(n) of the scan3 block Bsc3 is supplied to seventh and eighth transistors T7 and T8 (of FIG. 3) in each subpixel SP1 to SP4 of the odd and even horizontal pixel lines of the display area DA through the gate line GL, and the scan4 signal Sc4(n) of the scan4 block Bsc4 is supplied to a sixth transistor T6 (of FIG. 3) in each subpixel SP1 to SP4 of the odd and even horizontal pixel lines of the display area DA through the gate line GL. The emission signal Em(n) of the emission block Bem is supplied to fourth and fifth transistors T4 and T5 (of FIG. 3) in each subpixel SP1 to SP4 of the odd and even horizontal pixel lines of the display area DA through the gate line GL.

In another implementation, the first and second gate driving units 124 and 126 may have a symmetric structure. For example, each of the first and second gate driving units 124 and 126 may include the scan1 block Bsc1, the odd scan2 block Bsc2o, the even scan2 block Bsc2e, the scan3 block Bsc3, the scan4 block Bsc4 and the emission block Bem.

In FIG. 3, each of the first to fourth subpixels SP1 to SP4 of the display panel 128 of the display device 110 according to a first implementation of the present disclosure includes first to eighth transistors T1 to T8, a storage capacitor Cs and a light emitting diode De. At least one of the first to eighth transistors T1 to T8 may be an oxide semiconductor thin film transistor, and the others of the first to eighth transistors T1 to T8 may be low temperature polycrystalline silicon thin film transistor.

For example, the first, third, fourth, fifth, seventh and eighth transistors T1, T3, T4, T5, T7 and T8 may be a p-type low temperature polycrystalline silicon thin film transistor, and the second and sixth transistors T2 and T6 may be a n-type oxide semiconductor thin film transistor.

Further, the second and sixth transistors T2 and T6 may be transistors of a double gate type. As described herein, a transistor of a double gate type represents a transistor with two gate electrodes positioned on opposite sides of the semiconductor layer (one above and one below), which are electrically connected to and driven by the same control signal.

The first transistor T1 as a driving transistor is switched according to a voltage of a first capacitor electrode of the storage capacitor Cs. A gate electrode of the first transistor T1 is connected to a second node N2, a source electrode of the first transistor T1 is connected to a first node N1, and a drain electrode of the first transistor T1 is connected to a third node N3.

The second transistor T2 as a sampling transistor is switched according to a scan1 signal Sc1(n). A gate electrode (top and bottom gate electrodes) of the second transistor T2 is connected to the scan1 signal Sc1(n), a source electrode of the second transistor T2 is connected to the third node N3, and a drain electrode of the second transistor T2 is connected to the second node N2.

The third transistor T3 as a switching transistor is switched according to an odd scan2 signal Sc2o(n) or an even scan2 signal Sc2e(n). A gate electrode of the third transistor T3 is connected to the odd scan2 signal Sc2o(n) or the even scan2 signal Sc2e(n), a source electrode of the third transistor T3 is connected to the first node N1, and a drain electrode of the third transistor T3 is connected to the data signal Vda.

The fourth transistor T4 as an emitting transistor is switched according to an emission signal Em(n). A gate electrode of the fourth transistor T4 is connected to the emission signal Em(n), a source electrode of the fourth transistor T4 is connected to the third node N3, and a drain electrode of the fourth transistor T4 is connected to a fourth node N4.

The fifth transistor T5 as an emitting transistor is switched according to the emission signal Em(n). A gate electrode of the fifth transistor T5 is connected to the emission signal Em(n), a source electrode of the fifth transistor T5 is connected to the third node N3, and a drain electrode of the fifth transistor T5 is connected to the fourth node N4.

The sixth transistor T6 as an initializing transistor is switched according to a scan4 signal Sc4(n). A gate electrode (top and bottom electrodes) of the sixth transistor T6 is connected to the scan4 signal Sc4(n), a source electrode of the sixth transistor T6 is connected to an initial signal (initial voltage) Vin (e.g., about -5V), and a drain electrode of the sixth transistor T6 is connected to the second node N2.

The seventh transistor T7 as a reset transistor is switched according to a scan3 signal Sc3(n). A gate electrode of the seventh transistor T7 is connected to the scan3 signal Sc3(n), a source electrode of the seventh transistor T7 is connected to the fourth node N4, and a drain electrode of the seventh transistor T7 is connected to an anode reset signal (anode reset voltage) Var.

The eighth transistor T8 as a reset transistor is switched according to a scan3 signal Sc3(n). A gate electrode of the eighth transistor T8 is connected to the scan3 signal Sc3(n), a source electrode of the eighth transistor T8 is connected to the first node N1, and a drain electrode of the eighth transistor T8 is connected to a stress signal (stress voltage) Vobs.

The storage capacitor Cs stores the data signal Vda and the threshold voltage Vth. A first capacitor electrode of the storage capacitor Cs is connected to the second node N2, and a second capacitor electrode of the storage capacitor Cs is connected to the high level signal Vdd and the source electrode of the fourth transistor T4.

The light emitting diode De is connected between the fourth node N4 and the low level signal Vss to emit a light of a luminance proportional to a current of the first transistor T1. An anode of the light emitting diode De is connected to the fourth node N4, and a cathode of the light emitting diode De is connected to the low level signal Vss.

The source electrode of the first transistor T1, the source electrode of the third transistor T3, the drain electrode of the fourth transistor T4 and the source electrode of the eighth transistor T8 constitute the first node N1, and the gate electrode of the first transistor T1, the drain electrode of the second transistor T2, the first capacitor electrode of the storage capacitor Cs and the drain electrode of the sixth transistor T6 constitute the second node N2. The drain electrode of the first transistor T1, the source electrode of the second transistor T2 and the source electrode of the fifth transistor T5 constitute the third node N3, and the drain electrode of the fifth transistor T5, the source electrode of the seventh transistor T7 and the anode of the light emitting diode De constitute the fourth node N4.

A cross-sectional structure of each subpixel SP1 to SP4 of the display panel 128 of the display device 110 will be illustrated with reference to a drawing.

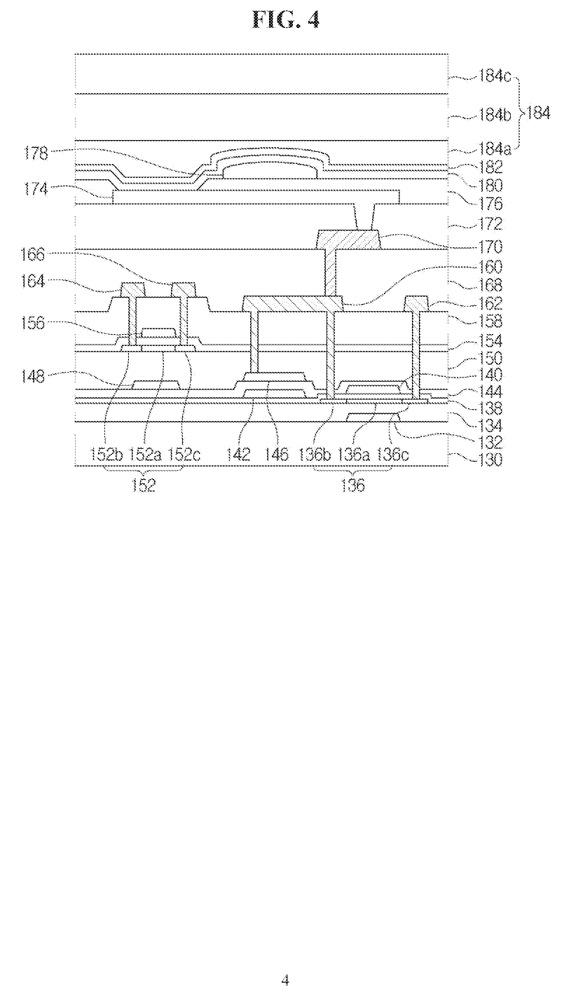

FIG. 4 is a cross-sectional view showing a subpixel of a display panel of a display device according to a first implementation of the present disclosure.

In FIG. 4, a first light shielding pattern 132 is disposed in each of the first to fourth subpixels SP1 to SP4 on a substrate 130, and a first buffer layer 134 is disposed on the first light shielding pattern 132 over the entire substrate 130.

The first light shielding pattern 132 may block a light incident from a lower portion of the substrate 130. For example, the first light shielding pattern 132 may have a single layer or a multiple layer of a metallic material such as molybdenum (Mo), aluminum (Al), chromium (Cr), gold (Au), titanium (Ti), nickel (Ni), neodymium (Nd), copper (Cu) and an alloy thereof.

The first buffer layer 134 may block a moisture or an oxygen permeating from an exterior. For example, the first buffer layer 134 may have a single layer or a multiple layer of an inorganic insulating material such as silicon oxide (SiO₂) and silicon nitride (SiNx).

A first semiconductor layer 136 is disposed on the first buffer layer 134 corresponding to the first light shielding pattern 132, and a first gate insulating layer 138 is disposed on the first semiconductor layer 136 over the entire substrate 130.

The first semiconductor layer 136 includes a first channel region 136a not doped with an impurity at a central portion thereof and first source and drain regions 136b and 136c doped with an impurity at both side portions of the first channel region 136a. For example, the first semiconductor layer 136 may include a polycrystalline semiconductor material such as polycrystalline silicon

For example, the first gate insulating layer 138 may have a single layer or a multiple layer of an inorganic insulating material such as silicon oxide (SiO₂) and silicon nitride (SiNx).

A first gate electrode 140 is disposed on the first gate insulating layer 138 corresponding to the first channel region 136a of the first semiconductor layer 136, and a first capacitor electrode 142 separated from the first gate electrode 140 is disposed on the first gate insulating layer 138. A first interlayer insulating layer 144 is disposed on the first gate electrode 140 and the first capacitor electrode 142 over the entire substrate 130.

The first gate electrode 140 and the first capacitor electrode 142 may have the same layer and the same material as each other. For example, the first gate electrode 140 and the first capacitor electrode 142 may have a single layer or a multiple layer of a metallic material such as molybdenum (Mo), aluminum (Al), chromium (Cr), gold (Au), titanium (Ti), nickel (Ni), neodymium (Nd), copper (Cu) and an alloy thereof.

For example, the first interlayer insulating layer 144 may have a single layer or a multiple layer of an inorganic insulating material such as silicon oxide (SiO₂) and silicon nitride (SiNx).

A second capacitor electrode 146 is disposed on the first interlayer insulating layer 144 corresponding to the first capacitor electrode 142, and a second light shielding pattern 148 separated from the second capacitor electrode 146 is disposed on the first interlayer insulating layer 144. A second buffer layer 150 is disposed on the second capacitor electrode 146 and the second light shielding pattern 148 over the entire substrate 130.

The second capacitor electrode 146 and the second light shielding pattern 148 may have the same layer and the same material as each other. For example, the second capacitor electrode 146 and the second light shielding pattern 148 may have a single layer or a multiple layer of a metallic material such as molybdenum (Mo), aluminum (Al), chromium (Cr), gold (Au), titanium (Ti), nickel (Ni), neodymium (Nd), copper (Cu) and an alloy thereof.

The first capacitor electrode 142, the first interlayer insulating layer 144 and the second capacitor electrode 146 may constitute the storage capacitor Cst.

The second buffer layer 150 may block a moisture or an oxygen permeating from an exterior. For example, the second buffer layer 150 may have a single layer or a multiple layer of an inorganic insulating material such as silicon oxide (SiO₂) and silicon nitride (SiNx).

A second semiconductor layer 152 is disposed on the second buffer layer 150 corresponding to the second light shielding pattern 148, and a second gate insulating layer 154 is disposed on the second semiconductor layer 152 over the entire substrate 130.

The second semiconductor layer 152 includes a second channel region 152a not conductorized at a central portion thereof and second source and drain regions 152b and 152c conductorized at both side portions of the second channel region 152a. For example, the second semiconductor layer 152 may include an oxide semiconductor material such as indium gallium zinc oxide (IGZO), zinc oxide (ZnO), tin oxide (SnO₂), copper oxide (Cu₂O), nickel oxide (NiO), indium tin zinc oxide (ITZO) and indium aluminum zinc oxide (IAZO).

For example, the second gate insulating layer 154 may have a single layer or a multiple layer of an inorganic insulating material such as silicon oxide (SiO₂) and silicon nitride (SiNx).

A second gate electrode 156 is disposed on the second gate insulating layer 154 corresponding to the second channel region 152a of the second semiconductor layer 152, and a second interlayer insulating layer 158 is disposed on the second gate electrode 156 over the entire substrate 130.

For example, the second gate electrode 156 may have a single layer or a multiple layer of a metallic material such as molybdenum (Mo), aluminum (Al), chromium (Cr), gold (Au), titanium (Ti), nickel (Ni), neodymium (Nd), copper (Cu) and an alloy thereof.

For example, the second interlayer insulating layer 158 may have a single layer or a multiple layer of an inorganic insulating material such as silicon oxide (SiO₂) and silicon nitride (SiNx).

A first source electrode 160, a first drain electrode 162, a second source electrode 164 and a second drain electrode 166 spaced apart from each other are disposed on the second interlayer insulating layer 158, and a first planarizing layer 168 is disposed on the first source electrode 160, the first drain electrode 162, the second source electrode 164 and the second drain electrode 166 over the entire substrate 130.

The first source electrode 160 and the first drain electrode 162 are connected to the first source region 136b and the first drain region 136c, respectively, of the first semiconductor layer 136 through contact holes in the second interlayer insulating layer 158, the second gate insulating layer 154, the second buffer layer 150, the first interlayer insulating layer 144 and the first gate insulating layer 138. The first source electrode 160 is connected to the second capacitor electrode 146 through a contact hole in the second interlayer insulating layer 158, the second gate insulating layer 154 and the second buffer layer 150.

The second source electrode 164 and the second drain electrode 166 are connected to the second source region 152b and the second drain region 152c, respectively, of the second semiconductor layer 152 through contact holes in the second interlayer insulating layer 158 and the second gate insulating layer 154.

The first source electrode 160, the first drain electrode 162, the second source electrode 164 and the second drain electrode 166 may have the same layer and the same material as each other. For example, the first source electrode 160, the first drain electrode 162, the second source electrode 164 and the second drain electrode 166 may have a single layer or a multiple layer of a metallic material such as molybdenum (Mo), aluminum (Al), chromium (Cr), gold (Au), titanium (Ti), nickel (Ni), neodymium (Nd), copper (Cu) and an alloy thereof.

For example, the first planarizing layer 168 may have a single layer or a multiple layer of an organic insulating material such as photoacryl and benzocyclobutene (BCB).

The first semiconductor layer 136, the first gate electrode 140, the first source electrode 160 and the first drain electrode 162 may constitute the fourth transistor T4, and the second semiconductor layer 152, the second gate electrode 156, the second source electrode 164 and the second drain electrode 166 may constitute the second transistor T2.

The first, third, fifth and eighth transistors T1, T3, T5, T7 and T8 may have the same cross-sectional structure as the fourth transistor T4, and the sixth transistor T6 may have the same cross-sectional structure as the second transistor T2.

A connecting electrode 170 is disposed on the first planarizing layer 168 corresponding to the first source electrode 160, and a second planarizing layer 172 is disposed on the connecting electrode 170 over the entire substrate 130.

The connecting electrode 170 is connected to the drain electrode of the fifth transistor T5 or the source electrode of the seventh transistor T7 through a contact hole in the first planarizing layer 168. For example, the connecting electrode 170 may be connected to the drain electrode of the fifth transistor T5 or the source electrode of the seventh transistor T7 having the same cross-sectional structure as the fourth transistor T4, and it is not limited thereto. For example, the connecting electrode 170 may be electrically connected to the second transistor T2, and the connecting electrode 170 may be electrically connected to the sixth transistor T6 having the same cross-sectional structure as the second transistor T2.

For example, the connecting electrode 170 may have a triple layer of a metallic material such as aluminum (Al) and titanium (Ti).

For example, the second planarizing layer 172 may have a single layer or a multiple layer of an organic insulating material such as photoacryl and benzocyclobutene (BCB).

A first electrode 174 is disposed on the second planarizing layer 172 corresponding to the connecting electrode 170, and a bank layer 176 is disposed on the first electrode 174.

The first electrode 174 is connected to the connecting electrode 170 through a contact hole in the second planarizing layer 172.

For example, the first electrode 174 may be an anode and may have a single layer or a multiple layer of a transparent conductive material such as indium tin oxide (ITO) and indium zinc oxide (IZO) or an opaque metallic material such as aluminum (Al), silver (Ag), copper (Cu), lead (Pb), molybdenum (Mo), titanium (Ti) and an alloy thereof.

The bank layer 176 covers an edge portion of the first electrode 174 and has an opening exposing a central portion of the first electrode 174.

For example, the bank layer 176 may have a single layer or a multiple layer of an organic insulating material such as photoacryl and benzocyclobutene (BCB).

A spacer 178 is disposed on the bank layer 176, an emitting layer 180 is disposed on the spacer 178 over the entire substrate 130, and a second electrode 182 is disposed on the emitting layer 180 over the entire substrate 130.

For example, the spacer 178 may have a single layer or a multiple layer of an organic insulating material such as photoacryl and benzocyclobutene (BCB).

The emitting layer 180 contacts the first electrode 174 exposed through the opening of the bank layer 176, a sidewall of the opening of the bank layer 176, a top surface of the bank layer 176 and side and top surfaces of the spacer 178.

The emitting layer 180 may include a hole assisting layer such as a hole injecting layer and a hole transporting layer, an emitting material layer and an electron assisting layer such as an electron transporting layer and an electron injecting layer.

For example, the second electrode 182 may be a cathode and may have a single layer or a multiple layer of a transparent conductive material such as indium tin oxide (ITO) and indium zinc oxide (IZO) or a half-transmissive or opaque metallic material such as aluminum (Al), silver (Ag), copper (Cu), lead (Pb), magnesium (Mg), molybdenum (Mo), titanium (Ti) and an alloy thereof.

The first electrode 174, the emitting layer 180 and the second electrode 182 may constitute the light emitting diode Del.

An encapsulating layer 184 preventing a permeation of a moisture is disposed on the second electrode 182 over the entire substrate 130. The encapsulating layer 184 includes a first encapsulating layer 184a, a second encapsulating layer 184b and a third encapsulating layer 184c sequentially disposed on the second electrode 182.

For example, the first encapsulating layer 184a and the third encapsulating layer 184c may have a single layer or a multiple layer of an inorganic insulating material such as silicon oxide (SiO₂) and silicon nitride (SiNx), and the second encapsulating layer 184b may include an organic insulating material such as an acryl resin, an epoxy resin, a phenolic resin, a polyamide resin and a polyimide resin.

A structure of the first, second and sixth transistors T1, T2 and T6 of each subpixel SP1 to SP4 of the display device 110 will be illustrated with reference to drawings.

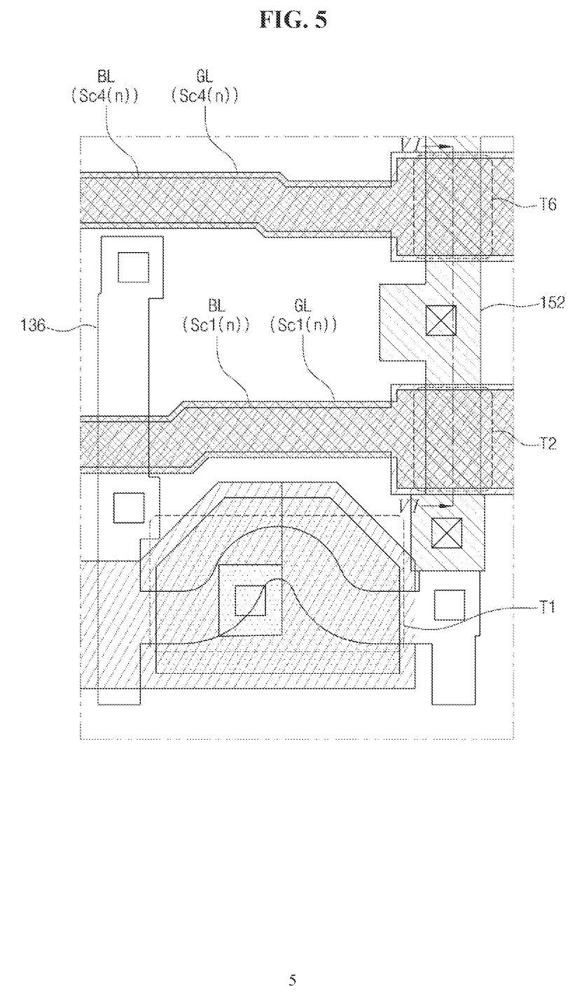

FIG. 5 is a plan view showing first, second and sixth transistors of a display device according to a first implementation of the present disclosure, and FIG. 6 is a cross-sectional view taken along a line VI-VI of FIG. 5.

In FIG. 5, in each of the first to fourth subpixels SP1 to SP4 of the display device 110 according to a first implementation of the present disclosure, a base line BL and the gate line GL transmitting the (n)th scan4 signal Sc4(n) and a base line BL and the gate line GL transmitting the (n)th scan1 signal Sc1(n) are sequentially disposed along a horizontal direction, and the first semiconductor layer 136 and the second semiconductor layer 152 are sequentially disposed along a vertical direction. The first semiconductor layer 136 may be bent along the horizontal direction to be connected to the second semiconductor layer 152.

The base line BL and the gate line GL transmitting the (n)th scan4 signal Sc4(n) cross the second semiconductor layer 152 to form the sixth transistor T6, and the base line BL and the gate line transmitting the scan1 signal Sc1(n) cross the second semiconductor layer 152 to form the second transistor T2.

The first transistor T1 includes a portion of the first semiconductor layer 136, the second transistor T2 includes a portion of the base line BL and the gate line GL transmitting the (n)th scan1 signal Sc1(n), and the sixth transistor T6 includes a portion of the base line BL and the gate line GL transmitting the (n)th scan4 signal Sc4(n).

In FIG. 6, the first buffer layer 134, the first gate insulating layer 138 and the first interlayer insulating layer 144 are sequentially disposed in each of the first to fourth subpixels SP1 to SP4 on the substrate 130, and the base line BL transmitting the (n)th scan4 signal Sc4(n) and the base line BL transmitting the (n)th scan1 signal Sc1(n) are spaced apart from each other on the first interlayer insulating layer 144.

The second buffer layer 150 is disposed on the base line BL transmitting the (n)th scan4 signal Sc4(n) and the base line BL transmitting the (n)th scan1 signal Sc1(n), and the second semiconductor layer 152 is disposed on the second buffer layer 150.

The second gate insulating layer 154 is disposed on the second semiconductor layer 152, and the gate line GL transmitting the (n)th scan4 signal Sc4(n) and the gate line GL transmitting the (n)th scan1 signal Sc1(n) are spaced apart from each other on the second gate insulating layer 154. The second interlayer insulating layer 158 is disposed on the gate line GL transmitting the (n)th scan4 signal Sc4(n) and the gate line GL transmitting the (n)th scan1 signal Sc1(n).

A portion of the base line BL transmitting the (n)th scan4 signal Sc4(n), the second buffer layer 150, the second semiconductor layer 152, the second gate insulating layer 154 and a portion of the gate line GL transmitting the (n)th scan4 signal Sc4(n) constitute the sixth transistor T6 of a double gate type. The portion of the base line BL transmitting the (n)th scan4 signal Sc4(n) and the portion of the gate line GL transmitting the (n)th scan4 signal Sc4(n) function as bottom and top gate electrodes, respectively, of the sixth transistor T6.

A portion of the base line BL transmitting the (n)th scan1 signal Sc1(n), the second buffer layer 150, the second semiconductor layer 152, the second gate insulating layer 154 and a portion of the gate line GL transmitting the (n)th scan1 signal Sc1(n) constitute the second transistor T2 of a double gate type. The portion of the base line BL transmitting the (n)th scan1 signal Sc1(n) and the portion of the gate line GL transmitting the (n)th scan1 signal Sc1(n) function as bottom and top gate electrodes, respectively, of the second transistor T2.

Reduction of a width of an initialization period in the display device 110 will be illustrated with reference to a drawing.

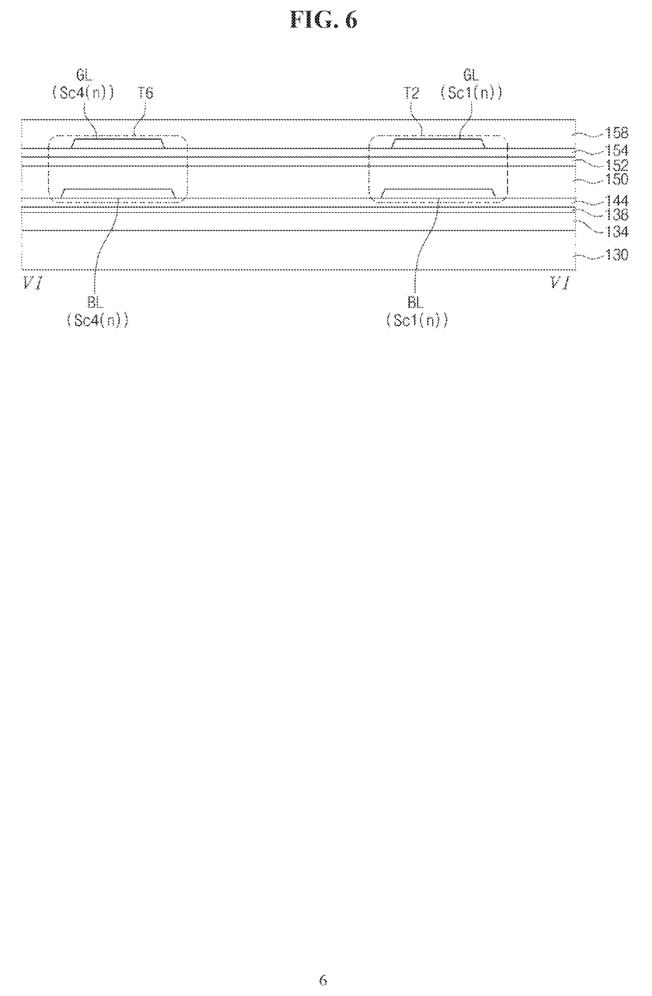

FIG. 7 is a view showing a plurality of signals of one frame of a display device according to a first implementation of the present disclosure.

In FIG. 7, during a first period TP1 as a reset period of one frame F of the display device 110 according to a first implementation of the present disclosure, the (n)th emission signal Em(n), the (n)th scan1 signal Sc1(n), the (n)th odd scan2 signal Sc2o(n) and the (n)th even scan2 signal Sc2e(n) of the odd and even horizontal pixel lines have a logic high voltage Vh (e.g., a voltage sufficient to place a transistor to which it is applied into an ON state), and the (n)th scan3 signal Sc3(n) and the (n)th scan4 signal Sc4(n) of the odd and even horizontal pixel lines have a logic low voltage Vl (e.g., a voltage sufficient to place a transistor to which it is applied into an OFF state).

As a result, the first, second, seventh and eighth transistors T1, T2, T7 and T8 are turned on, and the third, fourth, fifth and sixth transistors T3, T4, T5 and T6 are turned off. The stress signal Vobs is applied to the first, third and second nodes N1, N3 and N2 through the eighth, first and second transistors T8, T1 and T2, and the anode reset signal Var is applied to the fourth node N4 through the seventh transistor T7.

During the first period TP1, the first, second, third and fourth nodes N1, N2, N3 and N4 of the odd and even horizontal pixel lines are reset to prevent a hysteresis phenomenon due to a previous frame.

During a second period TP2 as an initialization period, the (n)th emission signal Em(n), the (n)th scan1 signal Sc1(n), the (n)th odd scan2 signal Sc2o(n), the (n)th even scan2 signal Sc2e(n), the (n)th scan3 signal Sc3(n) and the scan4 signal Sc4(n) of the odd and even horizontal pixel lines have a logic high voltage Vh.

As a result, the first, second and sixth transistors T1, T2 and T6 are turned on, and the third, fourth, fifth, seventh and eighth transistors T3, T4, T5, T7 and T8 are turned off. The initial signal Vin is applied to the second, third and first nodes N2, N3 and N1 through the sixth, second and first transistors T6, T2 and T1.

During the second period TP2, the second, third and first nodes N2, N3 and N1 of the odd and even horizontal pixel lines are reset to be initialized.

As such, the second period TP2, which is an initialization period, is included within the period of the logic high voltage Vh of the (n)th scan1 signal Sc1(n), and therefore can have a relatively small first width w1.

During a third period TP3 as a sampling period, the (n)th emission signal Em(n), the (n)th scan1 signal Sc1(n), the (n)th even scan2 signal Sc2e(n) and the (n)th scan3 signal Sc3(n) of the odd and even horizontal pixel lines have a logic high voltage Vh, and the (n)th odd scan2 signal Sc2o(n) and the (n)th scan4 signal Sc4(n) of the odd and even horizontal pixel lines have a logic low voltage Vl.

As a result, the first and second transistors T1 and T2 of the odd and even horizontal pixel lines and the third transistor T3 of the odd horizontal pixel line are turned on, and the third transistor T3 of the even horizontal pixel line and the fourth, fifth, sixth, seventh and eighth transistors T4, T5, T6, T7 and T8 of the odd and even horizontal pixel lines are turned off. The data signal Vda is applied to the second node N2 through the third, first and second transistors T3, T1 and T2.

During the third period TP3, the data signal Vda is applied to the second node N2 of the odd horizontal pixel line, and a sum (Vda+Vth) of the data signal Vda and the threshold voltage (Vth) of the first transistor T1 is applied to the gate electrode of the first transistor T1 and is stored in the storage capacitor Cs.

During a fourth period TP4 as a sampling period, the (n)th emission signal Em(n), the (n)th scan1 signal Sc1(n), the (n)th odd scan2 signal Sc2o(n) and the (n)th scan3 signal Sc3(n) of the odd and even horizontal pixel lines have a logic high voltage Vh, and the (n)th even scan2 signal Sc2e(n) and the (n)th scan4 signal Sc4(n) of the odd and even horizontal pixel lines have a logic low voltage Vl.

As a result, the first and second transistors T1 and T2 of the odd and even horizontal pixel lines and the third transistor T3 of the even horizontal pixel line are turned on, and the third transistor T3 of the odd horizontal pixel line and the fourth, fifth, sixth, seventh and eighth transistors T4, T5, T6, T7 and T8 of the odd and even horizontal pixel lines are turned off. The data signal Vda is applied to the second node N2 through the third, first and second transistors T3, T1 and T2.

During the fourth period TP4, the data signal Vda is applied to the second node N2 of the even horizontal pixel line, and a sum (Vda+Vth) of the data signal Vda and the threshold voltage (Vth) of the first transistor T1 is applied to the gate electrode of the first transistor T1 and is stored in the storage capacitor Cs.

During a fifth period TP5 as a reset period, the (n)th emission signal Em(n), the (n)th odd scan2 signal Sc2o(n) and the (n)th even scan2 signal Sc2e(n) of the odd and even horizontal pixel lines have a logic high voltage Vh, and the (n)th scan1 signal Sc1(n), the (n)th scan3 signal Sc3(n) and the (n)th scan4 signal Sc4(n) of the odd and even horizontal pixel lines have a logic low voltage Vl.

As a result, the first, seventh and eighth transistors T1, T7 and T8 of the odd and even horizontal pixel lines are turned on, and the second, third, fourth, fifth and sixth transistors T2, T3, T4, T5 and T6 of the odd and even horizontal pixel lines are turned off. The stress signal Vobs is applied to the first and third nodes N1 and N3 through the eighth and first transistors T8 and T1, and the anode reset signal Var is applied to the fourth node N4 through the seventh transistor T7.

During the fifth period TP5, the first, third and fourth nodes N1, N3 and N4 of the odd and even horizontal pixel lines are reset to prevent a hysteresis phenomenon due to a previous timing.

During a sixth period TP6 as an emission period, the (n)th odd scan2 signal Sc2o(n), the (n)th even scan2 signal Sc2e(n) and the (n)th scan3 signal Sc3(n) of the odd and even horizontal pixel lines have a logic high voltage Vh, and the (n)th emission signal Em(n), the scan1 signal Sc1(n) and the (n)th scan4 signal Sc4(n) of the odd and even horizontal pixel lines have a logic low voltage Vl.

As a result, the first, fourth and fifth transistors T1, T4 and T5 of the odd and even horizontal pixel lines are turned on, and the second, third, sixth, seventh and eighth transistors T2, T3, T6, T7 and T8 of the odd and even horizontal pixel lines are turned off. The high level signal Vdd is applied to the fourth node N4 through the fourth, first and fifth transistors T4, T1 and T5. The threshold voltage (Vth) is compensated in the turned-on first transistor T1, and a current corresponding to the data signal Vda flows through the turned-on first transistor T1.

During the sixth period TP6, the light emitting diode De emits a light corresponding to the data signal Vda of the present frame.

A first width w1 of the period of the logic high voltage Vh of the (n)th scan4 signal Sc4(n) of the display device 110 according to a first implementation of the present disclosure is smaller than a second width w2 of a period of the logic high voltage Vh of the (n)th scan4 signal Sc4(n) of a display device according to a comparison example. As a result, the second node N2 is charged to the same voltage even when the second transistor T2 of a sampling transistor has a different mobility.

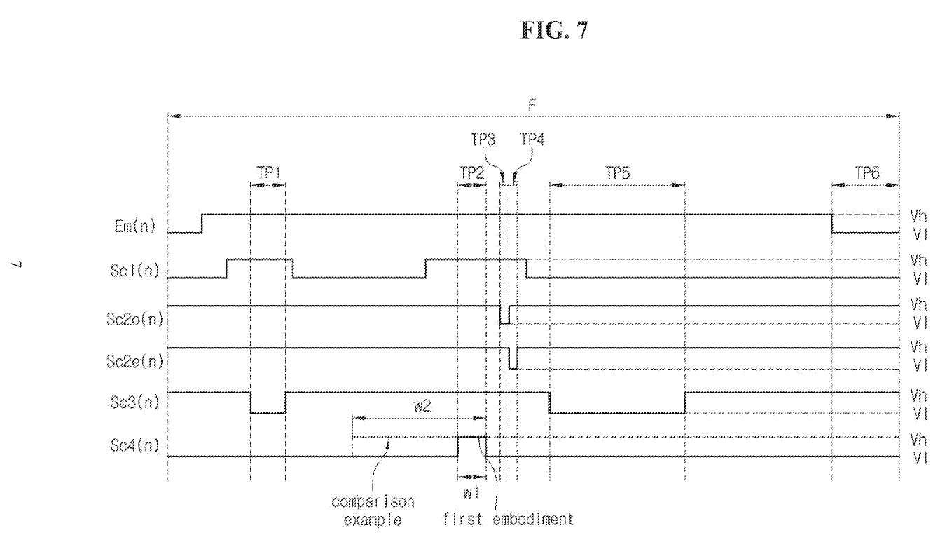

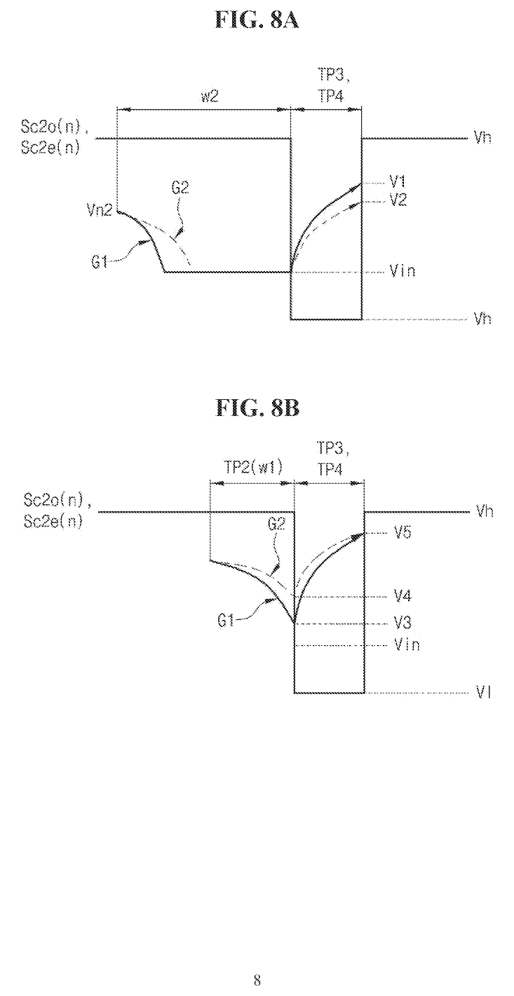

FIG. 8A is a view showing a second node voltage of a display device according to a comparison example, and FIG. 8B is a view showing a second node voltage of a display device according to a first implementation of the present disclosure.

In FIG. 8A, the period of the logic high voltage Vh of the (n)th scan4 signal Sc4(n) of the display device according to a comparison example has a relatively larger second width w2, and therefore the sixth transistor T6 is turned on during a relatively long period. As a result, in both of a case G1 (solid curve) where the second and sixth transistors T2 and T6 have a relatively high mobility and a case G2 (dashed curve) where the second and sixth transistors T2 and T6 have a relatively low mobility, a second node voltage Vn2 of the second node N2 is saturated during the width w2 period of the logic high voltage Vh of the (n)th scan4 signal Sc4(n) to be charged to the initial signal Vin.

Next, during the third and fourth periods TP3 and TP4 of the logic low voltage Vl of the (n)th odd scan2 signal Sc2o(n) and the (n)th even scan2 signal Sc2e(n), the third transistor T3 is turned on. In the case G1 (where the second and sixth transistors T2 and T6 have relatively high mobility), due to the relatively high charging speed, the second node voltage Vn2 (solid curve) quickly rises to a first voltage V1 higher than the initial signal Vin. However, in a case G2 (where the second and sixth transistors T2 and T6 have relatively low mobility), due to the relatively low charging speed, the second node voltage Vn2 (dashed curve) more slowly rises a second voltage V2 that is lower than the first voltage V1.

Accordingly, in the display device according to a comparison example, during the third and fourth periods TP3 and TP4 of a sampling period, the threshold voltage (Vth) stored in the storage capacitor Cs connected to the second node N2 can have different magnitudes due to a mobility deviation of the second and sixth transistors T2 and T6. This results in a threshold voltage difference across different regions of the display panel. Therefore, deterioration such as a local luminance deviation occurs and a display quality is reduced.

In FIG. 8B, by contrast, the second period TP2 of the logic high voltage Vh of the (n)th scan4 signal Sc4(n) of the display device 110 according to a first implementation of the present disclosure has a relatively small first width w1, and therefore the sixth transistor T6 is turned on during a relatively short period. As explained below, the result is that in both of the case G1 (where the second and sixth transistors T2 and T6 have relatively high mobility) and the case G2 (where the second and sixth transistors T2 and T6 have relatively low mobility), the second node voltage Vn2 of the second node N2 is not saturated during the smaller first width w1 period of the logic high voltage Vh of the (n)th scan4 signal Sc4(n).

Specifically, as shown in FIG. 8B, in the case G1 (where the second and sixth transistors T2 and T6 have relatively high mobility), despite the relatively high charging speed, the smaller first width w1 can ensure that the second node voltage Vn2 (solid curve) of the second node N2 is only charged to a third voltage V3 higher than the initial signal Vin. Therefore, the second node voltage Vn2 of the second node N2 is not saturated during the second period TP2 of the logic high voltage Vh of the (n)th scan4 signal Sc4(n). Also, in the case G2 (where the second and sixth transistors T2 and T6 have relatively low mobility), the relatively low charging speed ensures that the second node voltage Vn2 (dashed curve) of the second node N2 is charged to a fourth voltage V4 higher than the third voltage V3 (and also higher than the initial signal Vin). Therefore, again, the second node voltage Vn2 of the second node N2 is not saturated during the second period TP2 of the logic high voltage Vh of the (n)th scan4 signal Sc4(n).

The resulting benefits of the above-described non-saturation in the second period TP2 are shown next, namely during the third and fourth periods TP3 and TP4 (in which the (n)th odd scan2 signal Sc2o(n) and the (n)th even scan2 signal Sc2e(n) are each a logic low voltage Vl). Specifically, in the case G1 (where the second and sixth transistors T2 and T6 have relatively high mobility) the second node voltage Vn2 (solid curve) rises quickly from the third voltage V3 to a fifth voltage V5 due to a relatively high charging speed. In the case G2 (where the second and sixth transistors T2 and T6 have relatively low mobility) the second node voltage Vn2 (dashed curve) rises more slowly from the fourth voltage V4 to the same fifth voltage V5 due to a relatively low charging speed. Therefore, regardless of a mobility deviation of the second and sixth transistors T2 and T6 (e.g., regardless of case G1 or G2), the second node voltage Vn2 of second node N2 can have the same magnitude (fifth voltage V5).

Accordingly, in the display device 110 according to a first implementation of the present disclosure, during the third and fourth periods TP3 and TP4 of a sampling period, the threshold voltage (Vth) stored in the storage capacitor Cs connected to the second node N2 has the same magnitude regardless of a mobility deviation of the second and sixth transistors T2 and T6. This can help reduce a threshold voltage difference across different regions of the display panel 128. Therefore, deterioration such as a local luminance deviation is prevented and a display quality is improved.

In the display device 110 according to a first implementation of the present disclosure, during the second period TP2 which is an initialization period, the second node voltage Vn2 is not saturated regardless of the mobility deviation by regions of the second and sixth transistors T2 and T6. This can be achieved by determining the first width w1 as a relatively small value, during which the second node voltage Vn2 is charged to different voltages according to the mobility by regions of the second and sixth transistors T2 and T6.

In addition or as an alternative to using a smaller first width1, in some implementations, non-saturation can also be ensured by using a lower value of the initial signal Vin. For example, during the second period TP2, by determining the initial signal Vin as a relatively low voltage (e.g., about -6V to about -10V), the second node voltage Vn2 may be charged to different voltages according to the mobility by regions of the second and sixth transistors T2 and T6. As such, the second node voltage Vn2 may not be saturated regardless of the mobility deviation by regions of the second and sixth transistors T2 and T6.

In some implementations, the voltage of the scan1 signal Sc1(n) may increase due to a coupling of the scan2 signal Sc2(n).

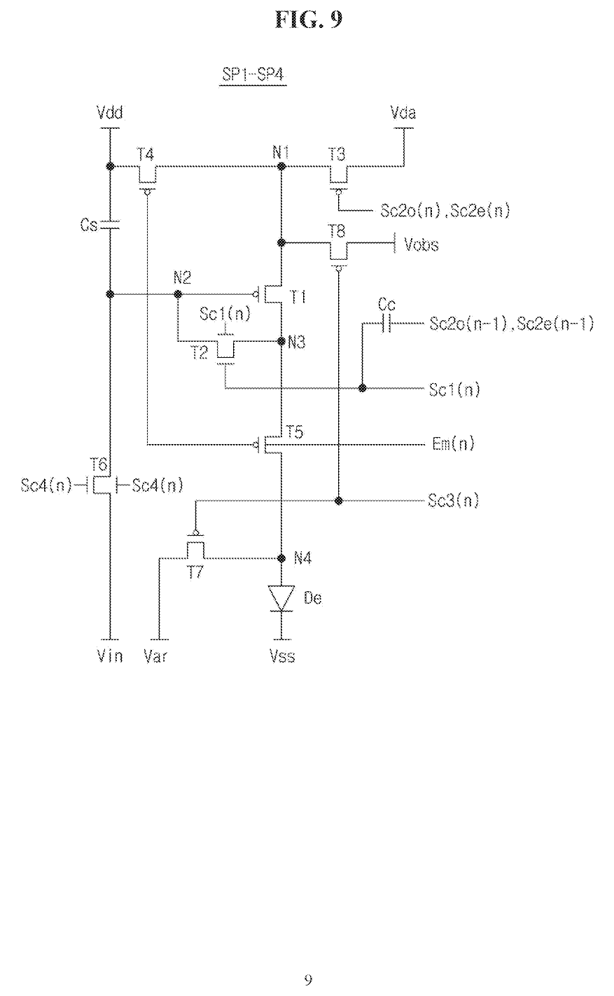

FIG. 9 is a circuit diagram showing a subpixel of a display device according to a second implementation of the present disclosure. Detailed description of parts that are the same as those of the first implementation will be omitted.

In FIG. 9, each of first to fourth subpixels SP1 to SP4 of a display device according to a second implementation of the present disclosure includes first to eighth transistors T1 to T8, a storage capacitor Cs, a coupling capacitor Cc and a light emitting diode De. At least one of the first to eighth transistors T1 to T8 may be an oxide semiconductor thin film transistor, and the others of the first to eighth transistors T1 to T8 may be low temperature polycrystalline silicon thin film transistor.

A connection structure and an operation of the first to eighth transistors T1 to T8, the storage capacitor Cs and the light emitting diode De of the second implementation are the same as those of the first implementation except that the coupling capacitor Cc is connected between a scan1 signal Sc1(n) and an odd scan2 signal Sc2o(n-1) or between a scan1 signal Sc1(n) and an even scan2 signal Sc2e(n-1).

The coupling capacitor Cc may be formed due to an overlapping of an output line of a scan1 block and a carry line in an even scan2 block of a first gate driving unit.

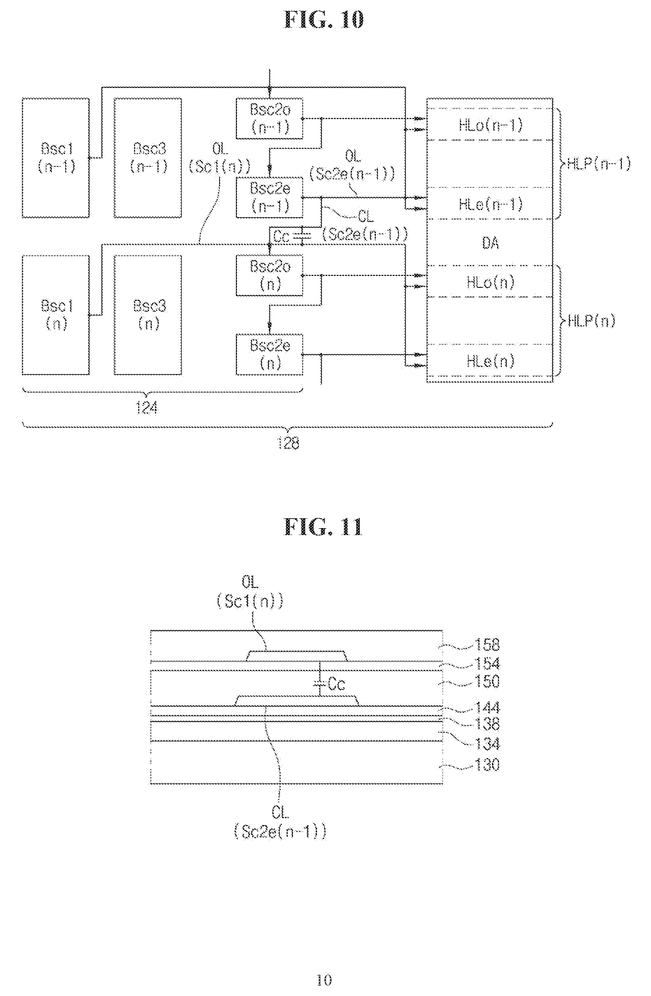

FIG. 10 is a view showing a first gate driving unit and a display panel of a display device according to a second implementation of the present disclosure, and FIG. 11 is a cross-sectional view showing an output line and a carry line of a first gate driving unit of a display device according to a second implementation of the present disclosure. Detailed description of parts that are the same as those of the first implementation will be omitted.

In FIG. 10, a first gate driving unit 124 in a non-display area NDA of a display panel 128 of a display device according to a second implementation of the present disclosure includes an (n-1)th scan1 block Bsc1(n-1), an (n)th scan1 block Bsc1(n), an (n-1)th odd scan2 block Bsc2o(n-1), an (n)th odd scan2 block Bsc2o(n), an (n-1)th even scan2 block Bsc2e(n-1), an (n)th even scan2 block Bsc2e(n), an (n-1)th scan3 block Bsc3(n-1) and an (n)th scan3 block Bsc3(n).

The (n-1)th scan1 block Bsc1(n-1) generates an (n-1)th scan1 signal Sc1(n-1) and supplies the (n-1)th scan1 signal Sc1(n-1) to odd and even horizontal pixel lines HLo(n-1) and HLe(n-1) of an (n-1)th horizontal pixel line pair HLP(n-1) in a display area DA through an output line OL.

The (n)th scan1 block Bsc1(n) generates an (n)th scan1 signal Sc1(n) and supplies the (n)th scan1 signal Sc1(n) to the odd and even horizontal pixel lines HLo(n-1) and HLe(n-1) of an (n)th horizontal pixel line pair HLP(n) in the display area DA through an output line OL.

The (n-1)th odd scan2 block Bsc2o(n-1) generates an (n-1)th odd scan2 signal Sc2o(n-1), supplies the (n-1)th odd scan2 signal Sc2o(n-1) to the odd horizontal pixel line HLo(n-1) of the (n-1)th horizontal pixel line pair HLP(n-1) in the display area DA through an output line OL, and supplies the (n-1)th odd scan2 signal Sc2o(n-1) to an (n-1)th even scan2 block Bsc2e(n-1) of a next stage in the non-display area NDA through a carry line CL.

The (n-1)th even scan2 block Bsc2e(n-1) generates an (n-1)th even scan2 signal Sc2e(n-1), supplies the (n-1)th even scan2 signal Sc2e(n-1) to the even horizontal pixel line HLe(n-1) of the (n-1)th horizontal pixel line pair HLP(n-1) in the display area DA through an output line OL, and supplies the (n-1)th even scan2 signal Sc2e(n-1) to an (n)th odd scan2 block Bsc2o(n) of a next stage in the non-display area NDA through a carry line CL.

The (n)th odd scan2 block Bsc2o(n) generates an (n)th odd scan2 signal Sc2o(n), supplies the (n)th odd scan2 signal Sc2o(n) to the odd horizontal pixel line HLo(n) of the (n)th horizontal pixel line pair HLP(n) in the display area DA through an output line OL, and supplies the (n)th odd scan2 signal Sc2o(n) to an (n)th even scan2 block Bsc2e(n) of a next stage in the non-display area NDA through a carry line CL.

The (n)th even scan2 block Bsc2e(n) generates an (n)th even scan2 signal Sc2e(n), supplies the (n)th even scan2 signal Sc2e(n) to the even horizontal pixel line HLe(n) of the (n)th horizontal pixel line pair HLP(n) in the display area DA through an output line OL, and supplies the (n)th even scan2 signal Sc2e(n) to an (n+1)th odd scan2 block Bsc2o(n+1) of a next stage in the non-display area NDA through a carry line CL.

The carry line CL of the (n-1)th even scan2 block Bsc2e(n-1) transmitting the (n-1)th even scan2 signal Sc2e(n-1) and the output line OL of the (n)th scan1 block Bsc1(n) transmitting the (n)th scan1 signal Sc1(n) overlap each other in the non-display area NDA to form the coupling capacitor Cc.

Although the output line OL of the (n)th scan1 block Bsc1(n) can overlap the carry line CL of the (n-1)th even scan2 block Bsc2e(n-1) in a second implementation of FIG. 10, the output line OL of the (n)th scan1 block Bsc1(n) may overlap the carry line CL of the (n-1)th odd scan2 block Bsc2o(n-1) in another implementation.

In FIG. 11, a first buffer layer 134, a first gate insulating layer 138 and a first interlayer insulating layer 144 are sequentially disposed in the non-display area NDA on a substrate 130, and the carry line CL transmitting the (n-1)th even scan2 signal Sc2e(n-1) is disposed on the first interlayer insulating layer 144.

A second buffer layer 150 and a second gate insulating layer 154 are sequentially disposed on the carry line CL transmitting the (n-1)th even scan2 signal Sc2e(n-1), the output line OL transmitting the (n)th scan1 signal Sc1(n) is disposed on the second gate insulating layer 154, and a second interlayer insulating layer 158 is disposed on the output line OL transmitting the (n)th scan1 signal Sc1(n).

The output line transmitting the (n)th scan1 signal Sc1(n) overlaps the carry line CL transmitting the (n-1)th even scan2 signal Sc2e(n-1) with the second gate insulating layer 154 and the second buffer layer 150 interposed therebetween to form the coupling capacitor Cc.

A voltage of the (n)th scan1 signal Sc1(n) increases due to a coupling of the (n-1)th even scan2 signal Sc2e(n-1) through the coupling capacitor Cc.

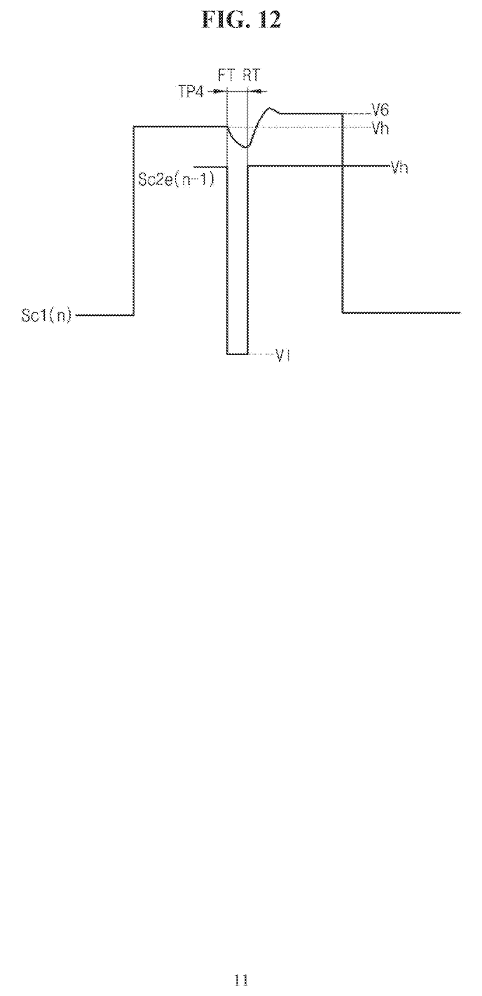

FIG. 12 is a view showing a scan1 signal and a scan2 signal of a display device according to a second implementation of the present disclosure. Detailed description of parts that are the same as those of the first implementation will be omitted.

In FIG. 12, a period of a logic high voltage Vh of the (n)th scan1 signal Sc1(n) overlaps a fourth period TP4 of a logic low voltage Vl of the (n-1)th even scan2 signal Sc2e(n-1). The period of a logic high voltage Vh of the (n)th scan1 signal Sc1(n) has a voltage variation at a falling timing FT and a rising timing RT of the (n-1)th even scan2 signal Sc2e(n-1) through the coupling capacitor Cc between the output line OL of the (n)th scan1 signal Sc1(n) and the carry line CL of the (n-1)th even scan2 signal Sc2e(n-1).

The voltage of the (n)th scan1 signal Sc1(n) decreases from the logic high voltage Vh at the falling timing FT of the (n-1)th even scan2 signal Sc2e(n-1) and increases again at the rising timing RT of the (n-1)th even scan2 signal Sc2e(n-1) to become a sixth voltage V6 greater than the logic high voltage Vh. Since a relatively high voltage is applied to the gate electrode of the second transistor T2, an on current of the second transistor T2 increases and a mobility of the second transistor is compensated.

In the display device according to a second implementation of the present disclosure, the voltage of the scan1 signal increases and the on current of the second transistor T2 of a sampling transistor increases by forming the coupling capacitor Cc between the output line OL of the scan1 signal Sc1 and the carry line CL of the scan2 signal Sc2 in the first and second gate driving units 124 and 126. As a result, a threshold voltage difference by regions in the display panel is minimized, deterioration such as a local luminance deviation is prevented, and a display quality is improved.

In another implementation, a coupling capacitor may be disposed in a subpixel.

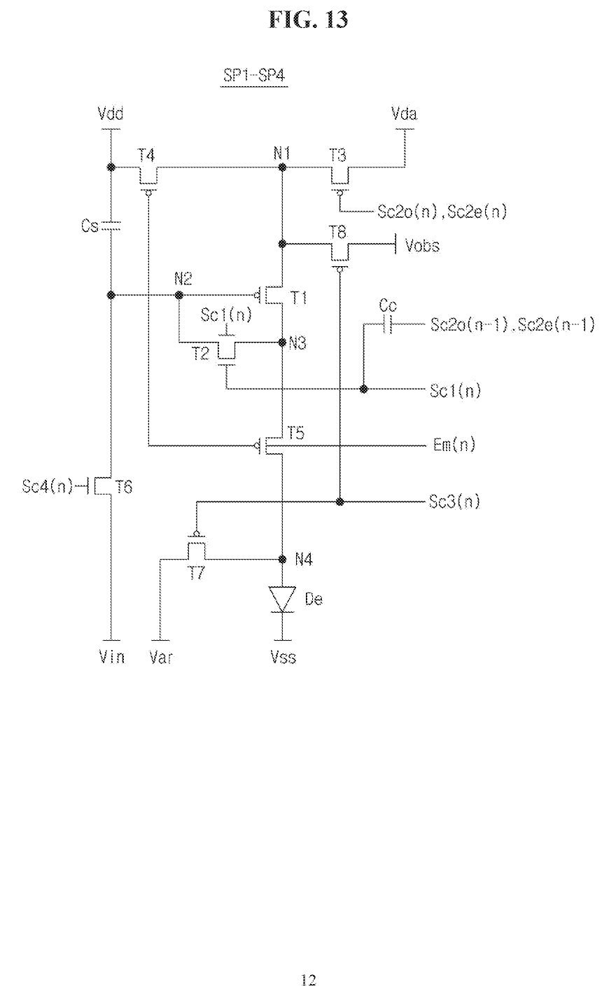

FIG. 13 is a view showing a subpixel of a display device according to a third implementation of the present disclosure. Detailed description of parts that are the same as those of the first and second implementations will be omitted.

In FIG. 13, each of first to fourth subpixels SP1 to SP4 of a display device according to a third implementation of the present disclosure includes first to eighth transistors T1 to T8, a storage capacitor Cs, a coupling capacitor Cc and a light emitting diode De. At least one of the first to eighth transistors T1 to T8 may be an oxide semiconductor thin film transistor, and the others of the first to eighth transistors T1 to T8 may be low temperature polycrystalline silicon thin film transistor.

A connection structure and an operation of the first to eighth transistors T1 to T8, the storage capacitor Cs and the light emitting diode De of the third implementation are the same as those of the first implementation except that the sixth transistor T6 has a single gate type where a gate electrode is disposed on a semiconductor layer to form a channel region at an upper portion of the semiconductor layer and the coupling capacitor Cc is connected between a scan1 signal Sc1(n) and an odd scan2 signal Sc2o(n-1) or between a scan1 signal Sc1(n) and an even scan2 signal Sc2e(n-1).

When the sixth transistor T6 has a single gate type, the channel region is formed only at the upper portion of the semiconductor layer, and the on current decreases. As a result, during a second period TP2 of a logic high voltage Vh of an (n)th scan4 signal Sc4(n), a second node N2 is charged up due to an initial signal Vin with a relatively low charging speed.

Similarly to the first implementation, a second node voltage Vn2 of the second node N2 is not saturated and is charged to a voltage higher than the initial voltage Vin, and a threshold voltage (Vth) stored in the storage capacitor Cs connected to the second node N2 has the same magnitude regardless of a mobility deviation of the second and sixth transistors T2 and T6 by regions during third and fourth periods TP3 and TP4. Accordingly, a threshold voltage difference by regions in the display panel is minimized, deterioration such as a local luminance deviation is prevented, and a display quality is improved.

The coupling capacitor Cc may be formed due to an overlapping of a gate line GL of a scan1 signal Sc1 and a base line BL of a scan2 signal Sc2 in each subpixel SP1 to SP4.

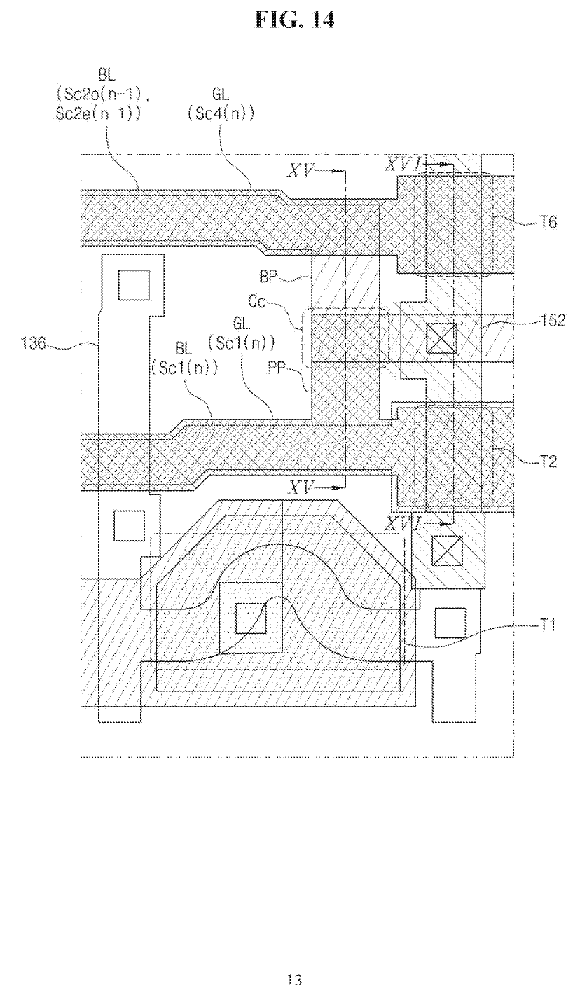

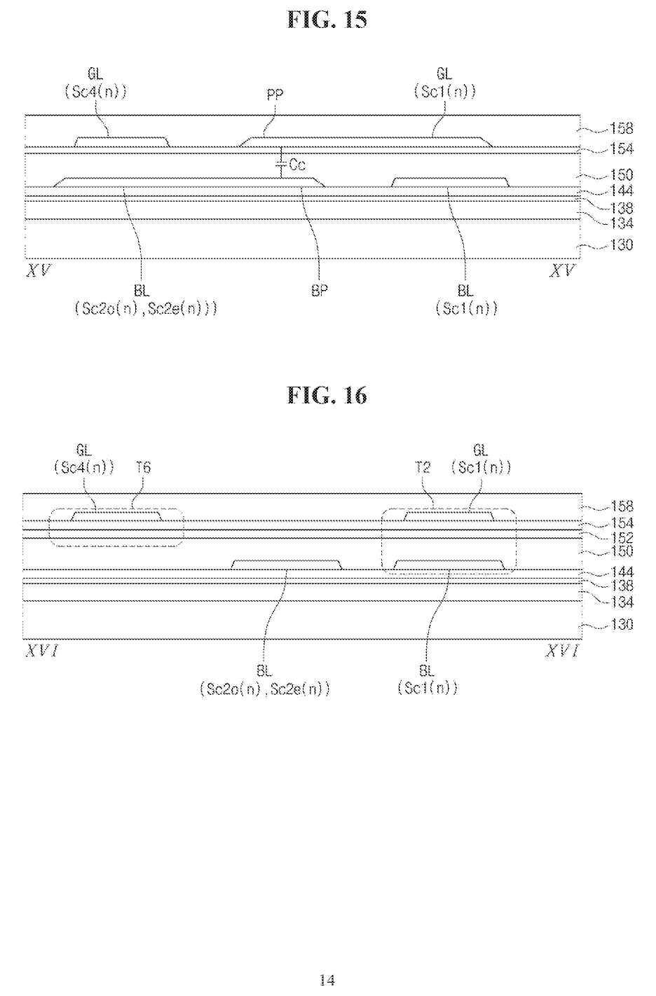

FIG. 14 is a plan view showing first, second and sixth transistors of a display device according to a third implementation of the present disclosure, FIG. 15 is a cross-sectional view taken along a line XV-XV of FIG. 14, and FIG. 16 is a cross-sectional view taken along a line XVI-XVI of FIG. 14. Detailed description of parts that are the same as those of the first and second implementations will be omitted.

In FIG. 14, in each of the first to fourth subpixels SP1 to SP4 of the display device according to a third implementation of the present disclosure, a base line BL transmitting the (n-1)th odd scan2 signal Sc2o(n-1) or the (n-1)th even scan2 signal Sc2e(n-1), a gate line GL transmitting the (n)th scan4 signal Sc4(n), and base and gate lines BL and GL transmitting the (n)th scan1 signal Sc1(n) are sequentially disposed along a horizontal direction, and a first semiconductor layer 136 and a second semiconductor layer 152 are sequentially disposed along a vertical direction. The first semiconductor layer 136 may be bent along the horizontal direction to be connected to the second semiconductor layer 152.

The gate line GL transmitting the (n)th scan4 signal Sc4(n) cross the second semiconductor layer 152 to form the sixth transistor T6, and the base and gate lines BL and GL transmitting the (n)th scan1 signal Sc1(n) cross the second semiconductor layer 152 to form the second transistor T2.

The first transistor T1 includes a portion of the first semiconductor layer 136, the second transistor T2 includes a portion of the base and gate lines BL and GL transmitting the (n)th scan1 signal Sc1(n), and the sixth transistor T6 includes a portion of the gate line GL transmitting the (n)th scan4 signal Sc4(n).

The base line BL transmitting the (n-1)th odd scan2 signal Sc2o(n-1) or the (n-1)th even scan2 signal Sc2e(n-1) is bent along the vertical direction to form a bent portion BP, and the gate line GL transmitting the (n)th scan1 signal Sc1(n) protrudes along the vertical direction to form a protruding portion PP. The bent portion BP of the base line BL of the (n-1)th odd scan2 signal Sc2o(n-1) or the (n-1)th even scan2 signal Sc2e(n-1) and the protruding portion PP of the gate line GL of the (n)th scan1 signal Sc1(n) overlap each other to form the coupling capacitor Cc.

In FIG. 15, the first buffer layer 134, the first gate insulating layer 138 and the first interlayer insulating layer 144 are sequentially disposed in each of the first to fourth subpixels SP1 to SP4 of the display area DA on the substrate 130, and the base line BL transmitting the (n-1)th odd scan2 signal Sc2o(n-1) or the (n-1)th even scan2 signal Sc2e(n-1) and the base line BL transmitting the (n)th scan4 signal Sc4(n) are spaced apart from each other on the first interlayer insulating layer 144.

The second buffer layer 150 and the second gate insulating layer 154 are sequentially disposed on the base line BL transmitting the (n-1)th odd scan2 signal Sc2o(n-1) or the (n-1)th even scan2 signal Sc2e(n-1) and the base line BL transmitting the (n)th scan1 signal Sc1(n).

The gate line GL transmitting the (n)th scan4 signal Sc4(n) and the gate line GL transmitting the (n)th scan1 signal Sc1(n) are spaced apart from each other on the second gate insulating layer 154, and the second interlayer insulating layer 158 is disposed on the gate line GL transmitting the (n)th scan4 signal Sc4(n) and the gate line GL transmitting the (n)th scan1 signal Sc1(n).

The protruding portion PP of the gate line GL transmitting the (n)th scan1 signal Sc1(n) overlaps the bent portion BP of the base line BL transmitting the (n-1)th odd scan2 signal Sc2o(n-1) or the (n-1)th even scan2 signal Sc2e(n-1) with the second gate insulating layer 154 and the second buffer layer 150 interposed therebetween to form the coupling capacitor Cc. A voltage of the (n)th scan1 signal Sc1(n) increases due to a coupling of the (n-1)th odd scan2 signal Sc2o(n-1) or the (n-1)th even scan2 signal Sc2e(n-1) through the coupling capacitor Cc.

In FIG. 16, the first buffer layer 134, the first gate insulating layer 138 and the first interlayer insulating layer 144 are sequentially disposed in each of the first to fourth subpixels SP1 to SP4 of the display area DA on the substrate 130, and the base line BL transmitting the (n-1)th odd scan2 signal Sc2o(n-1) or the (n-1)th even scan2 signal Sc2e(n-1) and the base line BL transmitting the (n)th scan1 signal Sc1(n) are spaced apart from each other on the first interlayer insulating layer 144.

The second buffer layer 150 is disposed on the base line BL transmitting the (n-1)th odd scan2 signal Sc2o(n-1) or the (n-1)th even scan2 signal Sc2e(n-1) and the base line BL transmitting the (n)th scan1 signal Sc1(n), and the second semiconductor layer 152 is disposed on the second buffer layer 150.

The second gate insulating layer 154 is disposed on the second semiconductor layer 152, the gate line GL transmitting the (n)th scan4 signal Sc4(n) and the gate line GL transmitting the (n)th scan1 signal Sc1(n) are spaced apart from each other on the second gate insulating layer 154, and the second interlayer insulating layer 158 is disposed on the gate line GL transmitting the (n)th scan4 signal Sc4(n) and the gate line GL transmitting the (n)th scan1 signal Sc1(n).

The second semiconductor layer 152, the second gate insulating layer 154 and a portion of the gate line GL transmitting the scan4 signal Sc4(n) constitute the sixth transistor T6 of a single gate type. The portion of the gate line GL transmitting the scan4 signal Sc4(n) functions as a top gate electrode of the sixth transistor T6.

A portion of the base line BL transmitting the (n)th scan1 signal Sc1(n), the second buffer layer 150, the second semiconductor layer 152, the second gate insulating layer 154 and a portion of the gate line GL transmitting the (n)th scan1 signal Sc1(n) constitute the second transistor T2 of a double gate type. The portion of the base line BL transmitting the (n)th scan1 signal Sc1(n) and the portion of the gate line GL transmitting the (n)th scan1 signal Sc1(n) function as bottom and top gate electrodes, respectively, of the second transistor T2.

In the display device according to a third implementation of the present disclosure, the voltage of the scan1 signal increases and the on current of the second transistor T2 of a sampling transistor increases by forming the coupling capacitor Cc between the gate line GL of the scan1 signal Sc1 and the base line BL of the scan2 signal Sc2 in each of the first to fourth subpixels SP1 to SP4. As a result, a threshold voltage difference by regions in the display panel is minimized, deterioration such as a local luminance deviation is prevented, and a display quality is improved.

It will be apparent to those skilled in the art that various modifications and variation may be made in the present disclosure without departing from the scope of the disclosure. Thus, it is intended that the present disclosure cover the modifications and variations of this disclosure provided they come within the scope of the appended claims and their equivalents.

What is claimed is:

1. A display device, comprising:
a display panel including a display area having a plurality of subpixels and a non-display area at a periphery of the display area;
a first transistor in each of the plurality of subpixels, the first transistor switched according to a voltage of a second node and connected to a first node and a third node;
a second transistor in each of the plurality of subpixels, the second transistor switched according to a scan1 signal and connected to the second node and the third node, and the second transistor having a double gate type;
a third transistor in each of the plurality of subpixels, the third transistor switched according to one of an odd scan2 signal and an even scan2 signal and connected to a data signal and the first node;
a fourth transistor in each of the plurality of subpixels, the fourth transistor switched according to an emission signal and connected to a high level signal and the first node;
a fifth transistor in each of the plurality of subpixels, the fifth transistor switched according to the emission signal and connected to the third node and a fourth node;
a sixth transistor in each of the plurality of subpixels, the sixth transistor switched according to a scan4 signal and connected to an initial signal and the second node;
a seventh transistor in each of the plurality of subpixels, the seventh transistor switched according to a scan3 signal and connected to an anode reset signal and the fourth node;
an eighth transistor in each of the plurality of subpixels, the eighth transistor switched according to the scan3 signal and connected to a stress signal and the first node; and
a light emitting diode in each of the plurality of subpixels, the light emitting diode connected to a low level signal and the fourth node.

2. The display device of claim 1, wherein a period of a logic high voltage of the scan1 signal includes a period of a logic high voltage of the scan4 signal.

3. The display device of claim 2, wherein, during the period of the logic high voltage of the scan4 signal, the second node is charged to a voltage higher than the initial signal.

4. The display device of claim 1, further comprising a coupling capacitor connected to the scan1 signal and one of the odd scan2 signal and the even scan2 signal.

5. The display device of claim 4, further comprising:
an output line in the non-display area and transmitting the scan1 signal; and
a carry line in the non-display area and transmitting one of the odd scan2 signal and the even scan2 signal,
wherein a portion of the output line and a portion of the carry line are disposed in different layers to overlap, with at least one insulating layer positioned between to form the coupling capacitor.

6. The display device of claim 5, further comprising:
a scan1 block in the non-display area and generating the scan1 signal; and
an odd scan2 block and an even scan2 block in the non-display area and generating the odd scan2 signal and the even scan2 signal, respectively,
wherein the scan1 block supplies the scan1 signal to the plurality of subpixels through the output line, and
wherein the odd scan2 block and the even scan2 block supply the odd scan2 signal and the even scan2 signal, respectively, to a next stage through the carry line.

7. The display device of claim 4, further comprising:
a scan1 base line and a scan1 gate line in each of the plurality of subpixels and transmitting the scan1 signal;
a scan2 base line in each of the plurality of subpixels and transmitting one of the odd scan2 signal and the even scan2 signal; and
a scan4 gate line in each of the plurality of subpixels and transmitting the scan4 signal,
wherein a portion of the scan1 gate line and a portion of the scan2 base line are disposed in different layers to overlap, with at least one insulating layer disposed therebetween, to form the coupling capacitor.

8. The display device of claim 7, wherein sixth transistor has a single gate type.

9. The display device of claim 1, further comprising a storage capacitor in each of the plurality of subpixels and connected to the high level signal and the second node,
wherein a source electrode of the first transistor, a source electrode of the third transistor, a drain electrode of the fourth transistor and a source electrode of the eighth transistor constitute the first node,
wherein a gate electrode of the first transistor, a drain electrode of the second transistor, a first capacitor electrode of the storage capacitor and a drain electrode of the sixth transistor constitute the second node,
wherein a drain electrode of the first transistor, a source electrode of the second transistor and a source electrode of the fifth transistor constitute the third node, and
wherein a drain electrode of the fifth transistor, a source electrode of the seventh transistor and an anode of the light emitting diode constitute the fourth node.

10. The display device of claim 9, wherein, during a first period, the emission signal, the scan1 signal, the odd scan2 signal and the even scan2 signal have a logic high voltage, and the scan3 signal and the scan4 signal have a logic low voltage,
wherein, during a second period, the emission signal, the scan1 signal, the odd scan2 signal, the even scan2 signal, the scan3 signal and the scan4 signal have a logic high voltage,
wherein, during a third period, the emission signal, the scan1 signal, the even scan2 signal and the scan3 signal have a logic high voltage, and the odd scan2 signal and the scan4 signal have a logic low voltage,
wherein, during a fourth period, the emission signal, the scan1 signal, the odd scan2 signal and the scan3 signal have a logic high voltage, and the even scan2 signal and the scan4 signal have a logic low voltage,
wherein, during a fifth period, the emission signal, the odd scan2 signal and the even scan2 signal have a logic high voltage, and the scan1 signal, the scan3 signal and the scan4 signal have a logic low voltage, and
wherein, during a sixth period, the odd scan2 signal, the even scan2 signal and the scan3 signal have a logic high voltage, and the emission signal, the scan1 signal and the scan4 signal have a logic low voltage.

11. A display device, comprising:
a display panel including a display area with a plurality of gate lines and a plurality of data lines;
a timing control circuit configured to apply gate signals to the plurality of gate lines;
a plurality of subpixels defined at intersections of the plurality of gate lines and the plurality of data lines;
a plurality of transistors in each of the plurality of subpixels; and
a light emitting diode in each of the plurality of subpixels,
wherein the plurality of transistors in each of the plurality of subpixels includes:
a sampling transistor switched according to a first gate signal and connected to a node, the second transistor having a double gate type, and
an initializing transistor switched according to a second gate signal and connected to the node and to an initial signal,
wherein a period of a logic high voltage of the first gate signal includes a period of a logic high voltage of the second gate signal, and
wherein, during the period of the logic high voltage of the second gate signal, the node is charged to a voltage higher than the initial signal.
